(19) United States
(12) Patent Application Publication
(10) Pub. No.: US 2021/0195661 A1
(43) Pub. Date: Jun. 24, 2021

(54) PRIORITIZED CALL HANDLING

(71) Applicant: Telefonaktiebolaget LM Ericsson (publ), Stockholm (SE)

(72) Inventor: Badawi YAMINE, Beirut (LB)

(21) Appl. No.: 17/252,996

(22) PCT Filed: Jun. 17, 2019
(86) PCT No.: PCT/EP2019/065807

§ 371 Date: Dec. 16, 2020

(30) Foreign Application Priority Data
Jun. 20, 2018 (EP) PCT/EP2018/066453

(51) Int. Cl. H04W 76/10; H04M 3/42; H04W 48/06; H04W 76/50

(52) U.S. Cl. CPC H04W 76/10; H04W 76/50; H04W 48/06; H04M 3/42187

(57) ABSTRACT

There is provided mechanisms for requesting prioritized call handling. A method is performed by a wireless device. The method includes obtaining an indication that the wireless device is experiencing a prioritized call situation. The indication dynamically triggers the wireless device to become part of a prioritized access class. The method includes requesting, during a call set-up procedure with a network node and only when the wireless device is experiencing the prioritized call situation, prioritized call handling.

### TECHNICAL FIELD

Embodiments presented herein relate to a method, a wireless device, a computer program, and a computer program product for requesting prioritized call handling. Further embodiments presented herein relate to a method, a network node, a computer program, and a computer program product for managing requested prioritized call handling from the wireless device. Further embodiments presented herein relate to a method, a network server, a computer program, and a computer program product for enabling management of prioritized call handling.

### BACKGROUND

In communications systems, there may be a challenge to obtain good performance and capacity for a given communications protocol, its parameters and the physical environment in which the communications system is deployed.

For example, one parameter in providing good performance and capacity for a given communications protocol in a communications system is the ability for users to efficiently report issues and to be able to communicate with emergency service operators when the users experience an emergency situation.

According to 3GPP TS 22.011 “Service accessibility”, version 16.1.0, common wireless devices belong to one of ten access class (0 to 9). The access class to which the wireless device belongs to is defined in the Subscriber Identity Module (SIM) module of the wireless device. A wireless device could be used also for some other specific tasks. These tasks are associated with access classes 11 to 15 and are as well defined as well in the SIM module of the wireless device. In particular, access class 11 is for ‘PLMN use’, access class 12 is for ‘Security services’, access class 13 is used for ‘Public Utilities (e.g. water/gas suppliers)’, access class 14 is used for ‘Emergency Services’ (such as for wireless devices belonging to police officers, fire fighters, and the like, on duty) and access class 15 is used for ‘PLMN Staff’ (whereas as already mentioned access classes 0 to 9 are for ‘normal subscribers’). One reason for having different access classes is to handle situations where a cell becomes congested. In such a situation, in order to reduce the network load, the network node might prevent wireless devices belonging to some access classes (e.g. access class 1 and access class 5) from accessing services in the communications system whilst still allowing wireless devices belonging to the other classes to access services in the communications system. Another reason for having different access classes is to handle situations where a new network node is installed. In such a situation, in order to perform tests (such as test calls) on the new network node (which is not yet ready for commercial use), the network operator might block calls of all access classes, except access class 15.

Users of two wireless devices of the same access class might experience very different situations; a first user experiencing an emergency incident and is in need of an emergency service, and a second user not experiencing any such emergency incident. However, the network node cannot distinguish between a call being made to/from the wireless device of the first user and a call being made to/from the wireless device of the second user. As a result, in case the network node that receives both calls request is congested, then as it could not distinguish between the two calls, there is a chance that the call of the user not experiencing any emergency incident is successfully processed whereas the call coming from the user experiencing the emergency incident is rejected.

Hence, there is a need for mechanisms that enable users experiencing emergency incidents to efficiently access emergency services.

### SUMMARY

An object of embodiments herein is to provide efficient prioritized call handling that can enable users experiencing emergency incidents to efficiently access emergency services.

According to a first aspect there is presented a method for requesting prioritized call handling. The method is performed by a wireless device. The method comprises obtaining an indication that the wireless device is experiencing a prioritized call situation. The indication dynamically triggers the wireless device to become part of a prioritized access class. The method comprises requesting, during a call set-up procedure with a network node and only when the wireless device is experiencing the prioritized call situation, prioritized call handling.

According to a second aspect there is presented a wireless device for requesting prioritized call handling. The wireless device comprises processing circuitry. The processing circuitry is configured to cause the wireless device to obtain an indication that the wireless device is experiencing a prioritized call situation. The indication dynamically triggers the wireless device to become part of a prioritized access class. The processing circuitry is configured to cause the wireless device to request, during a call set-up procedure with a network node and only when the wireless device is experiencing the prioritized call situation, prioritized call handling.

According to a third aspect there is presented a wireless device for requesting prioritized call handling. The wireless device comprises an obtain module configured to obtain an indication that the wireless device is experiencing a prioritized call situation. The indication dynamically triggers the wireless device to become part of a prioritized access class. The wireless device comprises a request module configured to request, during a call set-up procedure with a network node and only when the wireless device is experiencing the prioritized call situation, prioritized call handling.

According to a fourth aspect there is presented a computer program for requesting prioritized call handling. The computer program comprises computer program code which, when run on processing circuitry of a wireless device, causes the wireless device to perform a method according to the first aspect.

According to a fifth aspect there is presented a method for managing requested prioritized call handling from a wireless device. The method is performed by a network node. The method comprises obtaining, during a call set-up procedure with the wireless device, a request from the wireless device that the wireless device is requesting prioritized call handling. The method comprises prioritizing the call handling of the wireless device in response thereto. The network node thereby manages the requested prioritized call handling from the wireless device.

According to a sixth aspect there is presented a network node for managing requested prioritized call handling from a wireless device. The network node comprises processing circuitry. The processing circuitry is configured to cause the network node to obtain, during a call set-up procedure with the wireless device, a request from the wireless device that the wireless device is requesting prioritized call handling. The processing circuitry is configured to cause the network node to prioritize the call handling of the wireless device in response thereto. The network node thereby manages the requested prioritized call handling from the wireless device.

According to a seventh aspect there is presented a network node for managing requested prioritized call handling from a wireless device. The network node comprises an obtain module configured to obtain, during a call set-up procedure with the wireless device, a request from the wireless device that the wireless device is requesting prioritized call handling. The network node comprises a prioritize module configured to prioritize the call handling of the wireless device in response thereto. The network node thereby manages the requested prioritized call handling from the wireless device.

According to an eighth aspect there is presented a computer program for managing requested prioritized call handling from a wireless device. The computer program comprises computer program code which, when run on processing circuitry of a network node, causes the network node to perform a method according to the fifth aspect.

According to a ninth aspect there is presented a method for enabling management of prioritized call handling. The method is performed by a network server. The method comprises obtaining an indication of a call area in which call handling is to be prioritized. The call area thus defines a prioritized call area. The method comprises providing a notification of the indication to at least one network node serving the prioritized call area, thereby enabling the at least one network node to manage prioritized call handling in the prioritized call area.

According to a tenth aspect there is presented a network server for enabling management of prioritized call handling. The network server comprises processing circuitry. The processing circuitry is configured to cause the network server to obtain an indication of a call area in which call handling is to be prioritized. The call area thus defines a prioritized call area. The processing circuitry is configured to cause the network server to provide a notification of the indication to at least one network node serving the prioritized call area, thereby enabling the at least one network node to manage prioritized call handling in the prioritized call area.

According to an eleventh aspect there is presented a network server for enabling management of prioritized call handling. The network server comprises an obtain module configured to obtain an indication of a call area in which call handling is to be prioritized. The call area thus defines a prioritized call area. The network server comprises a provide module configured to provide a notification of the indication to at least one network node serving the prioritized call area, thereby enabling the at least one network node to manage prioritized call handling in the prioritized call area.

According to a twelfth aspect there is presented a computer program for enabling management of prioritized call handling, the computer program comprising computer program code which, when run on processing circuitry of a network server, causes the network server to perform a method according to the ninth aspect.

According to a thirteenth aspect there is presented a computer program product comprising a computer program according to at least one of the fourth aspect, the eight aspect, and the twelfth aspect and a computer readable storage medium on which the computer program is stored. The computer readable storage medium can be a non-transitory computer readable storage medium.

Advantageously these methods, these wireless devices, these network nodes, these network servers, and these computer programs enable users experiencing emergency incidents to efficiently access emergency services.

It is to be noted that any feature of the first, second, third, fourth, fifth, sixth seventh, eight, ninth, tenth, eleventh, twelfth, and thirteen aspects may be applied to any other aspect, wherever appropriate. Likewise, any advantage of the first aspect may equally apply to the second, third, fourth, fifth, sixth, seventh, eight, ninth, tenth, eleventh twelfth, and/or thirteenth aspect, respectively, and vice versa. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIGS. 1, 5, and 6 are schematic diagrams illustrating communications systems according to embodiments;

FIGS. 2, 3, 4, and 7 are flowcharts of methods according to embodiments;

FIG. 8 is a schematic diagram showing functional units of a wireless device according to an embodiment;

FIG. 9 is a schematic diagram showing functional modules of a wireless device according to an embodiment;

FIG. 10 is a schematic diagram showing functional units of a network node according to an embodiment;

FIG. 11 is a schematic diagram showing functional modules of a network node according to an embodiment;

FIG. 12 is a schematic diagram showing functional units of a network server according to an embodiment;

FIG. 13 is a schematic diagram showing functional modules of a network server according to an embodiment; and

FIG. 14 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art.

Like numbers refer to like elements throughout the description. Any step or feature illustrated by dashed lines should be regarded as optional.

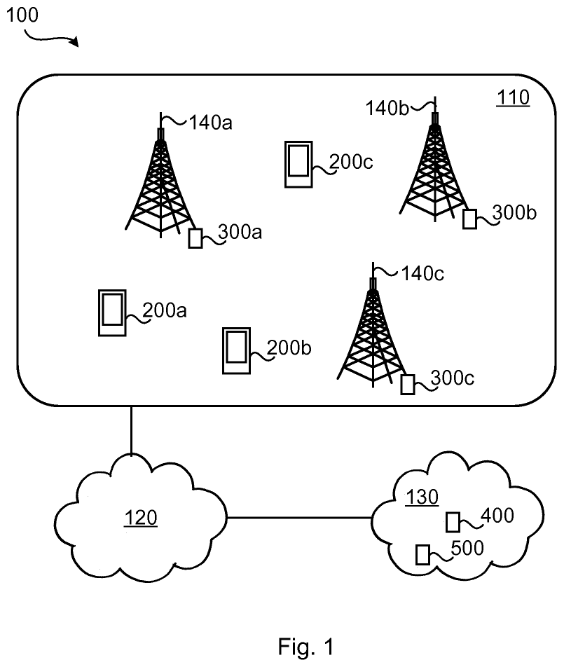

FIG. 1 is a schematic diagram illustrating a communications system 100 where embodiments presented herein can be applied. The communications system 100 comprises a radio access network 110 in which radio access network nodes 140a, 140b, 140c provide network access in cells, a core network 120, and a service network 130. The radio access network nodes 140a, 140b, 140c are controlled by network nodes 300a, 300b, 300c. The radio access network 110 is operatively connected to the core network 120 which in turn is operatively connected to the service network 130. The radio access network nodes 140a, 140b, 140c thereby enables wireless devices 200a, 200b, 200c to access services and exchange data as provided by the service network 130. Further, a network server 400 and an Operations Support System (OSS) 500 are located in the service network 130. Further details of the network server 400 and the OSS will be disclosed below.

Examples of wireless devices 200a, 200b, 200c include, but are not limited to, mobile stations, mobile phones, handsets, wireless local loop phones, user equipment (UE), smartphones, laptop computers, tablet computers, sensors, actuators, modems, repeaters, network-equipped Internet of Things devices, and network-equipped vehicles. Examples of network nodes 300a, 300b, 300c include, but are not limited to, radio base stations, base transceiver stations, Node Bs, evolved Node Bs, gNBs, and access points. As the skilled person understands, the communications system 100 may comprise a plurality of radio access network nodes 140a, 140b, 140c, each providing network access to a plurality of wireless devices 200a, 200b, 200c, and each controlled by a network node 300a, 300b, 300c. The herein disclosed embodiments are not limited to any particular number of radio access network nodes 140a, 140b, 140c, network nodes 300a, 300b, 300c, or wireless devices 200a, 200b, 200c.

As disclosed above there is a need for mechanisms that enable users experiencing emergency incidents to efficiently access emergency services.

For example, there could be occasions where one or more users initiates a call on a wireless device 200a, 200b, 200c while experiencing an emergency incident, such as being trapped in a dangerous area or suffering from a serious health condition. In one example the user might be trapped in building under fire. In another example the user is trapped under the wreckage of a roof after an earthquake. In yet another example the user is experiencing a heart attack, diabetes attack, or the like. Currently there is no way for the communications system (such as the network nodes 300a, 300b, 300c handling the call and their radio access network nodes 140a, 140b, 140c receiving the call) to distinguish calls for wireless devices 200a, 200b, 200c experiencing a prioritized call situation from calls for wireless devices 200a, 200b, 200c not experiencing any prioritized call situation.

The embodiments disclosed herein thus relate to mechanisms for requesting prioritized call handling. In order to obtain such mechanisms, there is provided a wireless device 200a, 200b, 200c, a method performed by the wireless device 200a, 200b, 200c, a computer program product comprising code, for example in the form of a computer program, that when run on processing circuitry of the wireless device 200a, 200b, 200c, causes the wireless device 200a, 200b, 200c to perform the method.

The embodiments disclosed herein further relate to mechanisms for managing requested prioritized call handling from a wireless device 200a, 200b, 200c. In order to obtain such mechanisms there is further provided a network node 300a, 300b, 300c, a method performed by the network node 300a, 300b, 300c, and a computer program product comprising code, for example in the form of a computer program, that when run on processing circuitry of the network node 300a, 300b, 300c, causes the network node 300a, 300b, 300c to perform the method.

The embodiments disclosed herein further relate to mechanisms for enabling management of prioritized call handling. In order to obtain such mechanisms, there is further provided a network server 400, a method performed by the network server 400, and a computer program product comprising code, for example in the form of a computer program, that when run on processing circuitry of the network server 400, causes the network server 400 to perform the method.

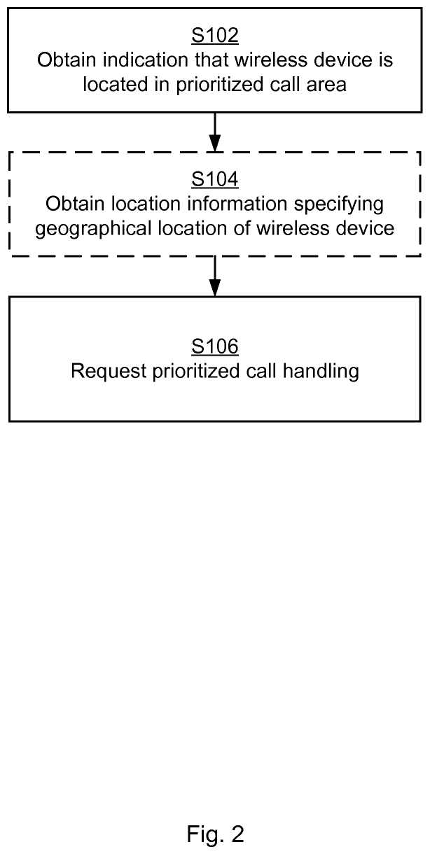

Reference is now made to FIG. 2 illustrating a method for requesting prioritized call handling as performed by the wireless device 200a, 200b, 200c according to an embodiment.

S102: The wireless device 200a, 200b, 200c obtains an indication that the wireless device 200a, 200b, 200c is experiencing a prioritized call situation.

The indication dynamically triggers the wireless device 200a, 200b, 200c to become part of a prioritized access class. In this respect, access group and access set are equivalents to access class. Moreover, the term “access class” may be generalized to other terminology than defined in standards.

S106: The wireless device 200a, 200b, 200c requests, during a call set-up procedure with a network node 300a, 300b, 300c and only when the wireless device 200a, 200b, 200c is experiencing the prioritized call situation, prioritized call handling.

Embodiments relating to further details of requesting prioritized call handling as performed by the wireless device 200a, 200b, 200c will now be disclosed.

In some aspects the prioritized access class allows the wireless device 200a, 200b, 200c to perform a call on a cell even when the cell is subject to access class barring. Thus, when the wireless device 200a, 200b, 200c becomes part of the prioritized access class then even though the network node 300a, 300b, 300c has, in the cell serving the wireless device 200a, 200b, 200c, activated access class barring (e.g. due to congestion) for all wireless device 200a, 200b, 200c belonging to any of access classes 0 to 9, all wireless device 200a, 200b, 200c having become part of the prioritized access class will be exempt from the access class barring and hence can trigger a high priority call in the cell.

There could be different ways for the wireless device 200a, 200b, 200c to specify that it is part of the prioritized access class. In some aspects the prioritized call has an establishment cause that is sent in a connection request message by the wireless device 200a, 200b, 200c to the network node 300a, 300b, 300c during the call set-up procedure. The establishment cause indicates the call to be prioritized. Existing establishment causes are specified in 3GPP TS 36.331, version 15.1.0. In this respect, during the call setup procedure, the wireless device 200a, 200b, 200c might specify, in a first radio resource control (RRC) message, such as a rrcConnectionRequest message, in the establishment cause of the call that the call is to be prioritized.

There could be different ways for the wireless device 200a, 200b, 200c to obtain the indication in step S102.

In some aspects the indication is obtained from a sensor. Particularly, according to an embodiment the indication is obtained from a sensor. The sensor either is collocated with the wireless device 200a, 200b, 200c or is an integral part of the wireless device 200a, 200b, 200c.

There could be different types of sensors from which the indication might be obtained. According to a non-limiting example the sensor is a temperature sensor, a gas sensor, or a health monitoring sensor. A temperature sensor could give an indication that the wireless device 200a, 200b, 200c is experiencing the prioritized call situation when the sensed temperature is higher than a predetermined level. A gas sensor could give an indication that the wireless device 200a, 200b, 200c is experiencing the prioritized call situation when the sensed gas level of a respective gas is above (such as for carbon oxide) or below (such as for oxygen) a respective predetermined level. A health monitoring sensor could give an indication that the wireless device 200a, 200b, 200c is experiencing the prioritized call situation when the sensed health aspect indicates a serious illness (e.g., heart frequency being above first threshold level or below second threshold level).

In other aspects the indication is obtained from the network. Particularly, according to an embodiment the indication is obtained as a notification from the network node 300a, 300b, 300c.

There could be different types of such notifications that are obtained from network node 300a, 300b, 300c. In some aspects the notification identifies a particular location, and the wireless device 200a, 200b, 200c compares its own location to the particular location identified in then notification and the uses the prioritized access class only when located within a predetermined range of the particular location identified in the notification. Particularly, according to an embodiment the notification specifies a geographic area defining a prioritized call area in which the prioritized call situation occurs. According to an embodiment the wireless device 200a, 200b, 200c is further configured to perform (optional) step S104:

S104: The wireless device 200a, 200b, 200c obtains location information specifying a current geographical location of the wireless device 200a, 200b, 200c. The wireless device 200a, 200b, 200c could then only request prioritized call handling when the current geographical location of the wireless device 200a, 200b, 200c is within a predefined distance from, or within, the geographic area defining the prioritized call area.

In general terms, the wireless device 200a, 200b, 200c must be aware of the existence of the prioritized access class in order for the wireless device 200a, 200b, 200c in order to be able to overcome the cell access class barring. There could be different ways for the wireless device 200a, 200b, 200c to be aware of the prioritized access class.

In some aspects the prioritized access class itself is received together with the notification from the network. Thus, according to an embodiment the prioritized access class is obtained from the network node 300a, 300b, 300c in conjunction with the notification.

In other aspects the prioritized access class is defined in the wireless device 200a, 200b, 200c itself but only activated upon the indication being obtained in step S102. Particularly, according to an embodiment the prioritized access class is provided in a subscriber identity module of the wireless device 200a, 200b, 200c.

There could be different types of prioritized access classes.

In some aspects the prioritized access class is a new access class relative to current standard definitions. For example, the prioritized access class might be defined as a dedicated access class number, e.g. access class 16.

In other aspects the prioritized access class is a modified existing access class. For example, the prioritized access class might be defined as a modification of any existing access class 0-15.

Hence, the prioritized access class might be established either by adding an additional access class (e.g., as access class 16) to the existing access classes (i.e., access classes 0 to 15) or by modifying an existing access class (e.g. access class 11).

Further, the wireless device 200a, 200b, 200c might at outset belong to an existing access class, such as any of access classes 0-9 and thus, only be triggered to belong to the prioritized access class upon having obtained the indication in step S102. Thus, according to an embodiment the wireless device 200a, 200b, 200c before obtaining the indication is part of another, non-prioritized, access class. Further, when the prioritized call situation ceases the wireless device 200a, 200b, 200c is triggered to return to the access class it belonged to before having obtained the indication in step S102.

It is to be noted that the access class as such is not signalled from the wireless device. Thus, the wireless device can use the prioritized establishment cause or similar as soon as it is somehow aware of its status as belonging to the prioritized access class and need not change its “original” access class. In this way the access class of the wireless device is applied conditionally which may allow override of access class barring when the wireless device is to be prioritized.

Reference is now made to FIG. 3 illustrating a method for managing requested prioritized call handling from a wireless device 200a, 200b, 200c as performed by the network node 300a, 300b, 300c according to an embodiment.

S208: The network node 300a, 300b, 300c obtains, during a call set-up procedure with the wireless device 200a, 200b, 200c, a request from the wireless device 200a, 200b, 200c that the wireless device 200a, 200b, 200c is requesting prioritized call handling. The wireless device 200a, 200b, 200c thereby indicates that it is experiencing a prioritized call situation.

S212: The network node 300a, 300b, 300c prioritizes the call handling of the wireless device 200a, 200b, 200c in response thereto (i.e., in response to having obtained the request in step S208). The network node 300a, 300b, 300c thereby manages the requested prioritized call handling from the wireless device 200a, 200b, 200c.

Embodiments relating to further details of managing requested prioritized call handling from a wireless device 200a, 200b, 200c as performed by the network node 300a, 300b, 300c will now be disclosed.

In some aspects the network node 300a, 300b, 300c grants the call handling of the wireless device 200a, 200b, 200c to be prioritized only after verification. Particularly, according to an embodiment the network node 300a, 300b, 300c is configured to perform (optional) step S210:

S210: The network node 300a, 300b, 300c verifies that call handling of the wireless device 200a, 200b, 200c is to be prioritized before prioritizing the call handling.

In some aspects step S210 is performed before step S212.

In some aspects the verification in step S210 is based on the network node 300a, 300b, 300c being aware that call is to be prioritized. Therefore, according to an embodiment the network node 300a, 300b, 300c is configured to perform (optional) step S202:

S202: The network node 300a, 300b, 300c obtains an indication that call handling of the prioritized call situation is to be prioritized.

Thereby, the network node 300a, 300b, 300c might check that such an indication indeed has been obtained as part of the verification in step S210. Thus, according to an embodiment the network node 300a, 300b, 300c is configured to perform (optional) step S210a:

S210a: The network node 300a, 300b, 300c confirms that the indication for the prioritized situation area has been obtained.

In some aspects step S210a is performed as part of step S210.

There could be different ways for the network node 300a, 300b, 300c to obtain the indication in step S208.

According to a first embodiment the indication is obtained as a notification from a network server 400 via the OSS 500.

According to a second embodiment the indication is derived from information obtained from at least one other wireless device 200a, 200b, 200c experiencing the prioritized call situation.

In some aspects the indication is only derived if information is obtained from a group of other wireless devices 200a, 200b, 200c experiencing the prioritized call situation. One reason for this is that if such a group of wireless devices 200a, 200b, 200c provides an indication of prioritized call situation then most probably all wireless devices 200a, 200b, 200c in the group are not faking that they are experiencing the prioritized call situation. In other aspects, the indication is still derived if the information is obtained from one single sensor, since it might be assumed that this single sensor is trusted and thus not likely to fake that it is experiencing the prioritized call situation. In yet further aspects, how many other wireless device 200a, 200b, 200c information needs to be obtain from depends on the expected network load; the higher the network load the higher number of other wireless device 200a, 200b, 200c must provide the information in order for the network node 200a, 200b, 200c to derive the indication.

There could be different ways for the network node 300a, 300b, 300c to act once having obtained the request in step S208.

In some aspects the network node 300a, 300b, 300c forwards a notification of the request to the network server 400. Particularly, according to an embodiment the network node 300a, 300b, 300c is configured to perform (optional) step S204:

S204: The network node 300a, 300b, 300c forwards the request to a network server 400.

Further, in some aspects the network node 300a, 300b, 300c broadcasts a notification of the prioritized call situation. Particularly, according to an embodiment the network node 300a, 300b, 300c is configured to perform (optional) step S202:

S206: The network node 300a, 300b, 300c broadcasts, in a cell served by the network node 300a, 300b, 300c, a notification of the prioritized call situation. The notification specifies a geographic area defining a prioritized call area of the prioritized call situation.

In some aspects the notification of the prioritized call situation is broadcast only when the network node 300a, 300b, 300c also is congested since otherwise there might be less need, or no need at all, for the wireless devices 200a, 200b, 200c to use the prioritized access class.

In further detail, the notification might be broadcast together with a request for the wireless devices 200a, 200b, 200c to estimate their location before attempting to establish a call since only wireless devices 200a, 200b, 200c within the prioritized call area will be part of a prioritized access class. Thus, if a wireless devices 200a, 200b, 200c estimates its own location to be outside the prioritized call area (but still within the cell), then there is a high risk that any call made from this wireless devices 200a, 200b, 200c will be subject to access class barring, thus wasting resource in the wireless devices 200a, 200b, 200c for attempting the call.

The broadcasting of the notification might continue as long as the prioritized call situation persists. However, once the prioritized call situation has been resolved, or otherwise ceased to exist, the broadcasting of the notification should also cease. Hence, according to an embodiment the network node 300a, 300b, 300c is configured to perform (optional) steps S214 and S216:

S214: The network node 300a, 300b, 300c obtains a further indication that prioritized call handling in the prioritized call area is to cease.

S216: The network node 300a, 300b, 300c stops broadcasting the notification in response thereto (i.e., in response to having obtained the further indication in step S214).

Thus, when a cell becomes congested then based on embodiments disclosed herein, all wireless devices 200a, 200b, 200c of access classes 0-9 in that cell will be divided into two or more groups:

A first group of wireless devices 200a, 200b, 200c not being triggered to become part of the prioritized access class (e.g. being located far away from an incident giving rise to a prioritized call situation) and hence not being abled to transmit and/or receive any call in the congested cell.

A second group of wireless devices 200a, 200b, 200c being triggered to become part of the prioritized access class (e.g. being located close to the incident) and hence still being abled to transmit and/or receive calls in the congested cell. The second group may be divided into subgroups having different priorities as described below.

According to an embodiment the call set-up procedure pertains to the wireless device 200a, 200b, 200c being served by the network node 300a, 300b, 300c in a cell. According to this embodiment the network node 300a, 300b, 300c is configured to perform (optional) step S212a when the cell is fully congested:

S212a: The network node 300a, 300b, 300c releases a connection with another wireless device 200a, 200b, 200c for which call handling is not prioritized in order to prioritize the call handling of the wireless device 200a, 200b, 200c.

In some aspects step S212a is performed as part of step S212.

In some further aspects the prioritized access class may be expanded by a further prioritization. In embodiments, wireless devices 200a, 200b, 200c may be differentiated, so that when two subscribers encounter or are located in the same ‘dangerous area’, e.g. the geographical area 550, the wireless device 200a, 200b, 200c that is closer to the incident will have a higher priority than a call triggered by a second wireless device 200a, 200b, 200c, which is more distant. Such enhancement could be performed by using sensors that detect the incident or by adding enhancement to the wireless network that could notify a wireless device 200a, 200b, 200c, not equipped with sensors, about the occurrence and location of a dangerous area.

Suppose that a fire occurs in a building at one floor, e.g. 10th floor. In prior art, at time of the incident, there is no differentiation in the priority between the call, call1, of a subscriber located in a dangerous area at the ground floor and another call, call2, triggered from the 10th floor. Note that during such incidents, there is a big risk that the cell, cell1, covering the area of the incident might become congested and at a certain point it will start rejecting calls. As a consequence, as there is no differentiation between the priority of calls triggered from a dangerous area, call2 (at 10th floor) who is in most need, might be rejected whereas call1 (at ground floor) who is farther away from the incident might be accepted.

In embodiments of the invention, values of a temperature sensor are divided in ranges where every range corresponds to a level of criticality that can be translated into a call priority. For example, if the value of temperature sensor of a first wireless UE1 device is above 80 degrees that means the situation where the wireless device is located is extremely critical whereas if the sensor value of another wireless device UE2 is between a 70-80 degrees that means this wireless device UE2 is in a less critical situation than UE1 and hence its call should have less priority in comparison to a call triggered by UE1.

According to a first further embodiment, under the new prioritized establishment cause (UE is in a dangerous area) another field called priority is proposed. That priority which is used only by UEs located in a ‘dangerous area’ works as follows: A call triggered by a subscriber who is most in danger, e.g. closest to the fire, will have a higher priority over a second call coming from another subscriber who is more distant from the fire than the first subscriber. In this embodiment, three priorities are proposed but more priorities could be defined.

In a second further embodiment, for all wireless devices equipped with sensors that detect a ‘dangerous area’ the priority is set as follows: a threshold is defined for every sensor and depending on the value of that threshold the priority of the establishment cause ‘UE is in a dangerous area’ is set accordingly.

For example, if the temperature of the sensor in UE1 is above 80 degrees, any call triggered by UE1 will have the first priority, whereas if temperature of the sensor at UE2 is between 70 and 80 degrees any call triggered by UE2 will have a second priority and any call coming by a UE with a temperature less than 70 degree will have the lowest priority.

Thus, a wireless device that is located in a ‘dangerous area’ is assigned to one of the three criticality levels, suitably named: extremely dangerous, very dangerous and dangerous.

This may be done depending on readings from one sensor of the wireless device. In a first example, for a temperature sensor, when the value is above 80 degrees Celsius that means the UE is located in an ‘extremely dangerous’ situation, whereas if the value is between 70 and 80 degree the UE will be classified as being in ‘very dangerous’ situation and if the sensor value is between 60 and 70 degrees that UE is classified as ‘dangerous’.

Alternatively, this may be done depending on classification of UEs that are not equipped with sensors done in two steps:
Step 1: UEs in the area are informed about an incident by the RN (Radio Node)
Step 2: The classification of the level of danger is done based on UE distance from the incident

Step 1:

In case the UE is not equipped with sensors that detect a ‘danger’, the network will send a notification of ‘UE in a dangerous area’ together with the location of the incident to all RN, e.g. RN1, that covers the area where the UE is facing the danger. This may be done based on one or both of the following two inputs:

IoT (Internet of Things) numerous sensors are implemented in the network at suitable places, such as in buildings, on the streets etc. Once they detect any danger (e.g. a fire) they report it to a server (IoT sensor server) which will forward it to an operator server such, as the network server 400, and that latest forward it to the OSS (Operations Support System) 500 which forward it to the radio access network nodes 140 a, 140b, 140c covering the area of the incident.

Subscriber complaints, e.g. one subscriber that faces a danger, calls the emergency number 112 and reports an incident emergency center that will report it to the operator server 400 which forward it to the OSS 500, in turn forwarding it to the radio access network nodes 140a, 140b, 140c covering the area of incident.

In the further embodiments, the network goes one step further by asking the affected radio access network nodes 140a, 140b, 140c to forward the received ‘UE in a dangerous area’ together with the location X of the incident to all

UEs under the coverage of the radio access network nodes 140a, 140b, 140c concerned.

Step 2:

In step 1, the UE receives:
Type of the incident
Location X of the incident,

In order to be able to classify the UE among the three levels of criticality, then in addition to above two inputs, a third information should be received by the UE denoted ‘distance thresholds’ which works as shown in below example:
If UE is within two meters from location X then based on the values received via ‘distance thresholds’ parameter it is considered as ‘extremely critical situation’. If UE is between 2 and 5 meters the situation is classified as ‘very critical’ and if the UE distance to the incident is between 5 and 10 meters than the situation is considered as ‘critical’. Then above 10 meters the call is considered as normal.

It should be noted that the values of the distance above are just examples, because in real life the exact values depend on the type of incidents. Sometimes the distance could be measured in meters and in other times it is measured in kilometers.

In other words, the calls triggered by UE in ‘dangerous area’ are classified into three categories. Once the UE is aware about which class it belongs to, it then converts each class into a call priority as follows:
If a UE belongs to a ‘extremely dangerous’ area and triggers a call, that call will have an establishmentcause ‘UE in a dangerous area’ will be given the highest priority 2.
If a UE belongs to a ‘very dangerous’ area and triggers a call, that call will have an establishmentcause ‘UE in a dangerous area’ and will be given the second highest priority 1.
If a UE belongs to a ‘dangerous’ area and triggers a call, that call will have an establishmentcause ‘UE in a dangerous area’ and will be given the lowest priority 0.

Two scenarios are studied:
The radio network, RN, is not congested (first scenario),
RN is congested (second scenario).

First scenario: If RN is not congested and it receives three calls as follows:
A first call received with establishmentcause ‘UE in a dangerous area’ and priority call=2,
A second call received with establishmentcause ‘UE in a dangerous area’ and priority call=0.
A third call received by a UE which is not situated in any ‘dangerous area’ (also called a normal call).

In such scenario all the three calls will be processed by the RN.

Second scenario: If RN is congested, which is likely the case when any dangerous incident occurs in a cell, then the highest priority calls will take priority over lower priority calls. This is illustrated in the following examples where we assume, for simplicity, the maximum capacity of a cell is 100 calls.
Suppose that at t1, there were 80 normal calls and 20 calls with establishmentcause ‘UE in a dangerous area’. Suppose also that the priorities of these 20 calls which are in ‘danger’ are diversified (0, 1 and 2).
Suppose that at t2, there were 5 normal calls and 95 calls with establishmentcause ‘UE in a dangerous area’, and a new call, call_x, with establishmentcause ‘UE in a dangerous area’ is received by the RN. Then whatever is the priority of call_x a normal call is released and call_x is processed so that the total number call of UE in danger becomes 96 and normal calls becomes 4. This is done because any call with establishmentcause ‘UE in a dangerous area’ (whatever is its priority) has a higher priority over a normal call.
Suppose that at t3, all the 100 connected calls on the cell have an establishmentcause ‘UE in a dangerous area’ and a new call, call y also with establishmentcause ‘UE in a dangerous area’ has been triggered. In such scenario one of the below three options is executed depending on the call priority:
If call_y priority is 2, then one of the loo connected calls with lower priority (either 1 or 0) will be released and call_y is processed. Note that in case all the loo connected calls have already priority 2 then new incoming call_y will be rejected due to cell congestion.
If call_y priority is 1, then if one of the 100 connected calls has a priority 0, it will be released so that the new call_y is processed. However, if from all the loo connected calls, none of them has a priority 0, then the new call_y will be rejected as the cell is already congested with calls of equal (priority equal 1) or of higher priority (priority equal 2).
If call_y priority is o then the call will be rejected as all existing calls on the cell (100 calls) have a priority equal to 0 or higher.

Reference is now made to FIG. 4 illustrating a method for enabling management of prioritized call handling as performed by the network server 400 according to an embodiment.

S302: The network server 400 obtains an indication of a call area in which call handling is to be prioritized. The call area thus defines a prioritized call area.

S304: The network server 400 provides a notification of the indication to at least one network node 300a, 300b, 300c serving the prioritized call area. The network node 400 thereby enables the at least one network node 300a, 300b, 300c to manage prioritized call handling in the prioritized call area.

Embodiments relating to further details of enabling management of prioritized call handling as performed by the network server 400 will now be disclosed.

There may be different ways for the network server 400 to obtain the indication in step S302.

According to a first example the indication is obtained from an emergency service center. There could be different types of emergency service center, such as a law enforcement (e.g. police) service center, a fire and rescue (e.g. fire fighting brigade) service center, an emergency medical (e.g. accident & emergency department at a hospital) service center. The emergency service center might be associated with, or operatively connected to, an emergency service center server 450a.

According to a second example the indication is obtained from at least one sensor device located in the prioritized call area. In this respect, the indication might be obtained directly from the at least one sensor device or via a sensor server 450b of the at least one sensor device.

According to a third example the indication is obtained, via a network node 300a, 300b, 300c and the OSS 500, from at least one wireless device 200a, 200b, 200c located in the prioritized call area.

According to an embodiment the prioritized call area corresponds to a geographic area. The indication might then be caused by an incident having occurred in the geographic area. According to an embodiment the indication then identifies the geographic area and type of incident having occurred.

There may be different ways for the network server 400 to provide the notification to the at least one network node 300a, 300b, 300c in step S304.

According to an embodiment the notification is provided to the at least one network node 300a, 300b, 300c via the OSS 500.

In some aspects the notification is not only provided to the network node 300a, 300b, 300c serving the call area of the prioritized call area but also to at least one other network node 300a, 300b, 300c neighbouring this call area. Particularly, according to an embodiment the notification further is provided to at least one network node 300a, 300b, 300c serving a call area neighbouring the prioritized call area.

FIG. 5 schematically illustrates a part 100a of the communications system boo of FIG. 1 comprising a network node 300a associated with a radio access network node 140a and three wireless devices 200a, 200b, 200c. For illustrative purposes it is assumed that the network node 300a is congested. It is further assumed that the network node 300a has an ongoing call with wireless device 200c. Wireless device 200b is the only one of the wireless devices utilizing the prioritized access class.

S401: Wireless device 200a requests setup of a call and sends an rrcConnectionRequest message with establishmentcause=‘mo-data’ to the network node 300a.

S402: Since the network node 300a is congested, it responds to wireless device 200a with an rrcConnectionReject message, whereby the call is rejected due to congestion.

S403: Wireless device 200b experiences a prioritized call situation and requests setup of a call and therefore sends an rrcConnectionRequest message with establishmentcause =‘prioritized’ to the network node 300a.

S404: The network node 300a responds with an rrcConnectionSetup message, whereby the call is accepted.

S405: Since the network node 300a is congested, acceptance of the call from wireless device 200b forces the network node 300a to release the ongoing call with wireless device 200c. Hence, the network node 300a sends an rrcConnectionRelease message to wireless device 200c, whereby its call is terminated.

FIG. 6 schematically illustrates a part 100b of the communications system 100 of FIG. 1 comprising network nodes 300a, 300b, 300c associated with radio access network nodes 140a, 140b, 140c, a network server 400, an emergency service center server 450a, a sensor server 450b, and the OSS 500. A wireless device 200a is equipped with a sensor and is experiencing a prioritized call situation whilst being located in a geographical area 550.

It is assumed that wireless device 200a experiences a prioritized call situation and thus at least one of steps S501a and step S501c is entered:

S501a: Another wireless device 200b in the same geographical area 550 as wireless device 200a, requests a call set up for an emergency call , e.g. by dialing an emergency call number, such as 112 or 911, to the network node 300a. The network node 300a accepts the emergency call.

S501b: The network node 300a forwards an indication of the emergency call situation to an emergency service center server 450a.

S501c: A wireless device embodied as a sensor 200c and implemented by the operator is located in the same geographical area 550 as wireless devices 200a, 200b and provides an indication of the prioritized call situation to sensor server 450b.

The network server 400 is configured to collect information about emergency call situations from the emergency service center server 450a and the sensor server 450b.

Thus, depending on which step S501a and/or S501c was entered, at least one of steps S502a and S502b is entered:

S502a: The emergency service center server 450a sends a notification of the prioritized call situation to the network server 400.

S502b: The sensor server 450b sends a notification of the prioritized call situation to the network server 400.

The notifications in steps S502a and S502b comprise an indication of a call area in which call handling is to be prioritized, where the call area is defined by the geographical area 550 in which the wireless device 200a is located.

The network server 400 is configured to provide a notification of the indication at least to the network node 300a serving the prioritized call area, and optionally also to the network node 300b neighbouring that network node 300a in order to enable prioritized call handling in the prioritized call area. The network server 400 forwards the notification to the OSS 500 for further forwarding to network nodes 300a, 300b, and hence steps S503, S504a, S504b, and S504c are performed:

S503: The network server 400 forwards a single notification based on all respective notifications to the OSS 500.

S504a: The OSS 500 forwards the notification to network node 300a serving the prioritized call area.

S504b: The OSS 500 forwards the notification to network node 300b neighbouring the network node 300a serving the prioritized call area.

S504c: No notification is sent to network node 300c since network node 300c neither serves the prioritized call area, nor is neighbouring the network node 300a serving the prioritized call area.

FIG. 7 is a flowchart of a method for handling a prioritized call situation based on at least some of the above disclosed embodiments.

S601: The network node 300a is notified about the existence of a prioritized call situation and thus obtains a notification of the prioritized call situation from the OSS.

S602: The network node 300a checks if its cell is congested. If no, step S603 is entered, and if yes, step S604 is entered.

S603: The network node 300a processes all calls, regardless of access class prioritization.

S604: The network node 300a, as a consequence of its cell being congested, applies access class barring.

S605: The network node 300a broadcasts, in the prioritized call area or the entire served cell, a notification of the prioritized call situation. The notification specifies a geographic area defining a prioritized call area of the prioritized call situation.

S606: The wireless device checks whether it is located in the prioritized call area or not. If no, step S607 is entered, and if yes, step S608 is entered.

S607: The wireless device is subjected to access class barring and thus any initiation of calls to/from the wireless device is rejected.

S608: The wireless device, since it is deemed to be located within the prioritized call area, becomes part of the prioritized access class and hence will be exempt from access class barring.

S609: The network node 300a accepts initiation of calls to/from the wireless device since the wireless device temporarily belongs to the prioritized access class. As a consequence thereof, an ongoing call for a wireless device not belonging to the prioritized access class might be released.

S610: The network node 300a checks whether the prioritized call situation still exists. If no, step S602 is entered, and if yes, step S611 is entered.

S611: The network node 300a stops its broadcasts of the notification of the prioritized call situation in the prioritized call area, which thus no longer is deemed to be a prioritized call area. The wireless device within the, thus formerly, prioritized call area becomes part of its normal access class. Step S601 can then be entered once again.

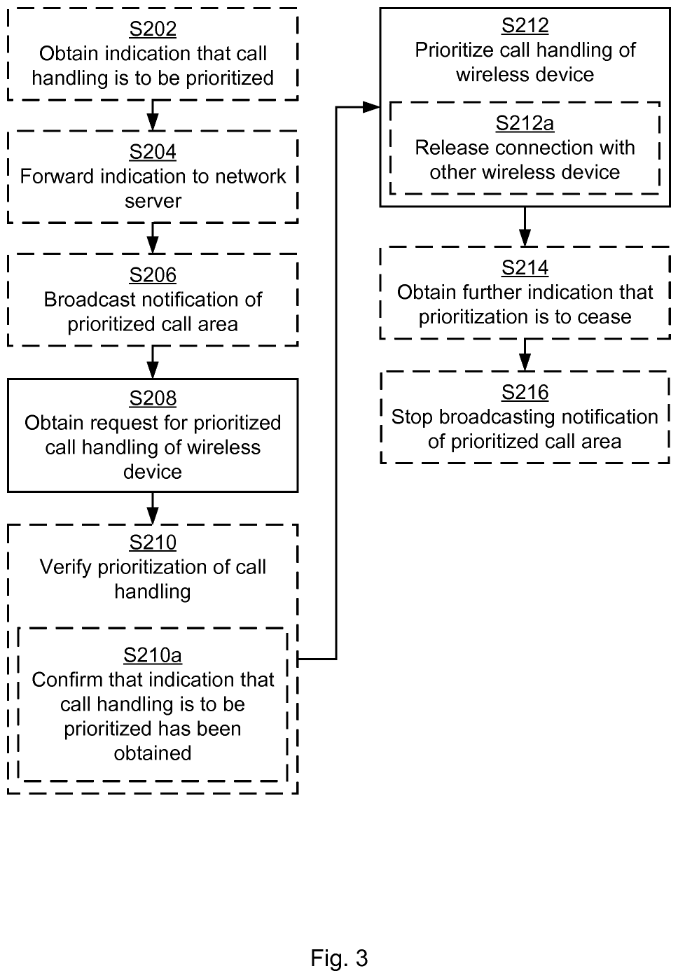

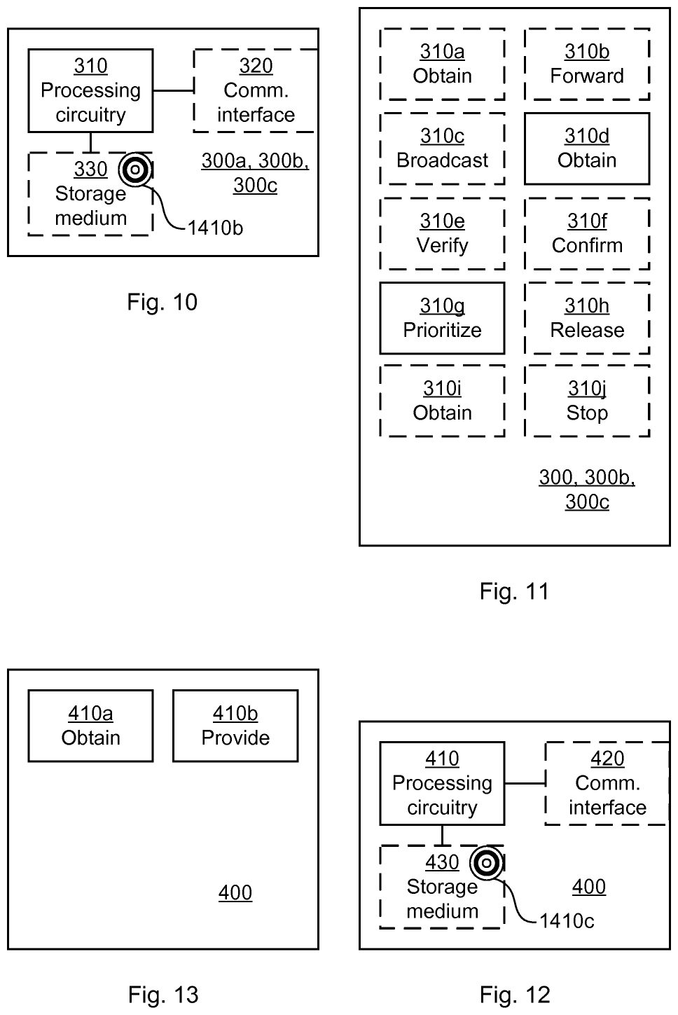

FIG. 8 schematically illustrates, in terms of a number of functional units, the components of a wireless device 200a, 200b, 200c according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1410a (as in FIG. 14), e.g. in the form of a storage medium 230. The processing circuitry 210 may further be provided as at least one application specific integrated circuit (ASIC), or field programmable gate array (FPGA).

Particularly, the processing circuitry 210 is configured to cause the wireless device 200a, 200b, 200c to perform a set of operations, or steps, as disclosed above. For example, the storage medium 230 may store the set of operations, and the processing circuitry 210 may be configured to retrieve the set of operations from the storage medium 230 to cause the wireless device 200a, 200b, 200c to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The wireless device 200a, 200b, 200c may further comprise a communications interface 220 for communications with other entities, nodes, functions, and devices as herein disclosed. As such the communications interface 220 may comprise one or more transmitters and receivers, comprising analogue and digital components.

The processing circuitry 210 controls the general operation of the wireless device 200a, 200b, 200c e.g. by sending data and control signals to the communications interface 220 and the storage medium 230, by receiving data and reports from the communications interface 220, and by retrieving data and instructions from the storage medium 230. Other components, as well as the related functionality, of the wireless device 200a, 200b, 200c are omitted in order not to obscure the concepts presented herein.

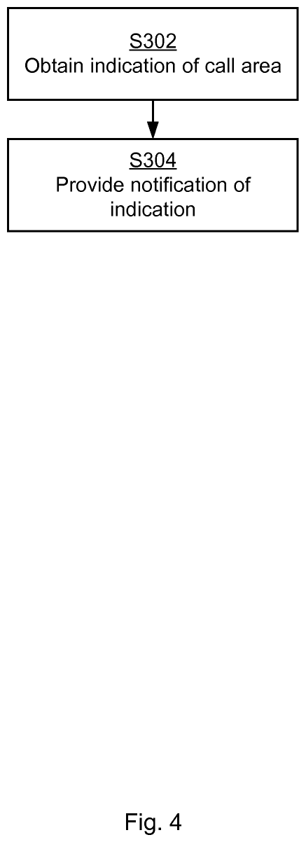

FIG. 9 schematically illustrates, in terms of a number of functional modules, the components of a wireless device 200a, 200b, 200c according to an embodiment. The wireless device 200a, 200b, 200c of FIG. 9 comprises a number of functional modules; a first obtain module 210a configured to perform step S102, and a request module 210c configured to perform step S106. The wireless device 200a, 200b, 200c of FIG. 9 may further comprise a number of optional functional modules, such as a second obtain module 210b configured to perform step S104. In general terms, each functional module 210a-210c may be implemented in hardware or in software. Preferably, one or more or all functional modules 210a-210c may be implemented by the processing circuitry 210, possibly in cooperation with the communications interface 220 and the storage medium 230. The processing circuitry 210 may thus be arranged to from the storage medium 230 fetch instructions as provided by a functional module 210a-210c and to execute these instructions, thereby performing any steps of the wireless device 200a, 200b, 200c as disclosed herein.

Examples of wireless devices 200a, 200b, 200c have been given above.

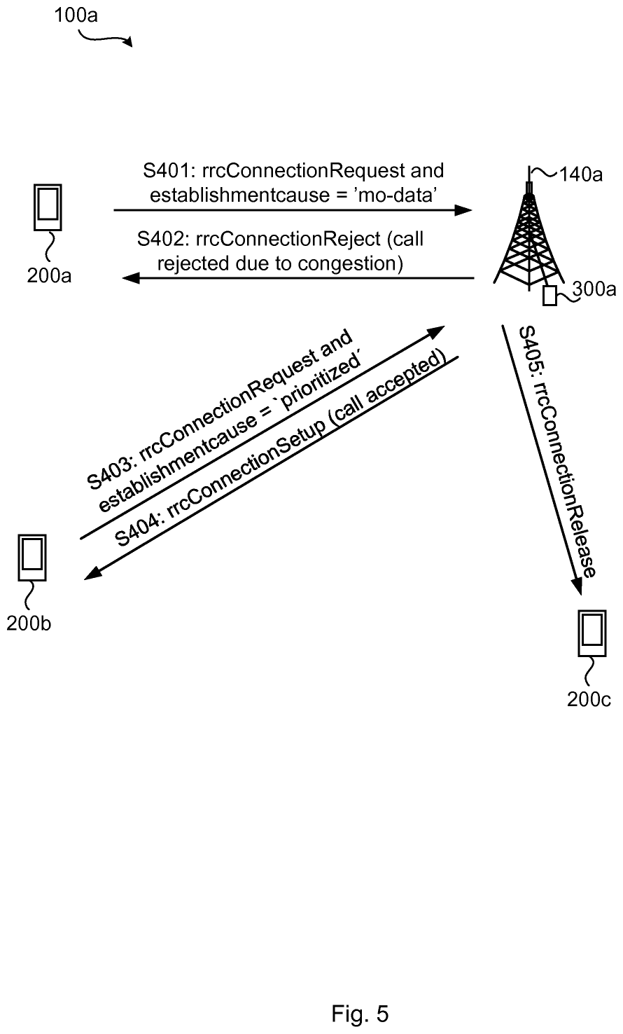

FIG. 10 schematically illustrates, in terms of a number of functional units, the components of a network node 300a, 300b, 300c according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1410b (as in FIG. 14), e.g. in the form of a storage medium 330. The processing circuitry 310 may further be provided as at least one application specific integrated circuit (ASIC), or field programmable gate array (FPGA).

Particularly, the processing circuitry 310 is configured to cause the network node 300a, 300b, 300c to perform a set of operations, or steps, as disclosed above. For example, the storage medium 330 may store the set of operations, and the processing circuitry 310 may be configured to retrieve the set of operations from the storage medium 330 to cause the network node 300a, 300b, 300c to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The network node 300a, 300b, 300c may further comprise a communications interface 320 for communications with other entities, nodes, functions, and devices as herein disclosed. As such the communications interface 320 may comprise one or more transmitters and receivers, comprising analogue and digital components.

The processing circuitry 310 controls the general operation of the network node 300a, 300b, 300c e.g. by sending data and control signals to the communications interface 320 and the storage medium 330, by receiving data and reports from the communications interface 320, and by retrieving data and instructions from the storage medium 330. Other components, as well as the related functionality, of the network node 300a, 300b, 300c are omitted in order not to obscure the concepts presented herein.

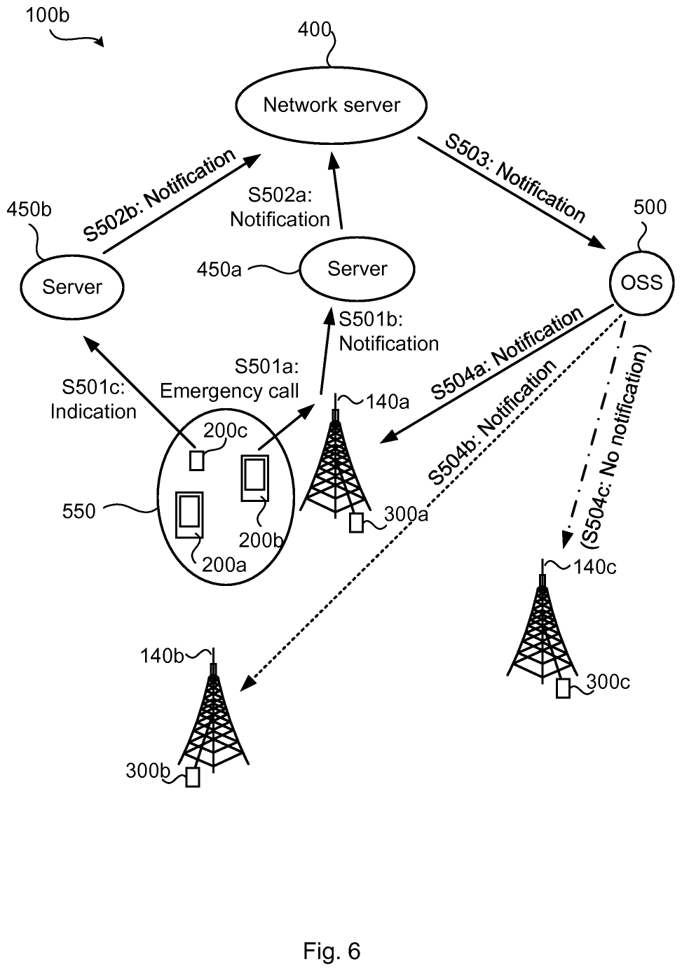

FIG. 11 schematically illustrates, in terms of a number of functional modules, the components of a network node 300a, 300b, 300c according to an embodiment. The network node 300a, 300b, 300c of FIG. 11 comprises a number of functional modules; a second obtain module 310d configured to perform step S208, and a prioritize module 310g configured to perform step S212. The network node 300a, 300b, 300c of FIG. 11 may further comprise a number of optional functional modules, such as any of a first obtain module 310a configured to perform step S202, a forward module 310b configured to perform step S204, a broadcast module 310c configured to perform step S206, a verify module 310e configured to perform step S210, a confirm module 310f configured to perform step S210a, a release module 310h configured to perform step S212a, a third obtain module 310i configured to perform step S214, and a stop module 310k configured to perform step S216.

In general terms, each functional module 310a-310j may be implemented in hardware or in software. Preferably, one or more or all functional modules 310a-310j may be implemented by the processing circuitry 310, possibly in cooperation with the communications interface 320 and the storage medium 330. The processing circuitry 310 may thus be arranged to from the storage medium 330 fetch instructions as provided by a functional module 310a-310j and to execute these instructions, thereby performing any steps of the network node 300a, 300b, 300c as disclosed herein.

Examples of network nodes 300a, 300b, 300c have been given above.

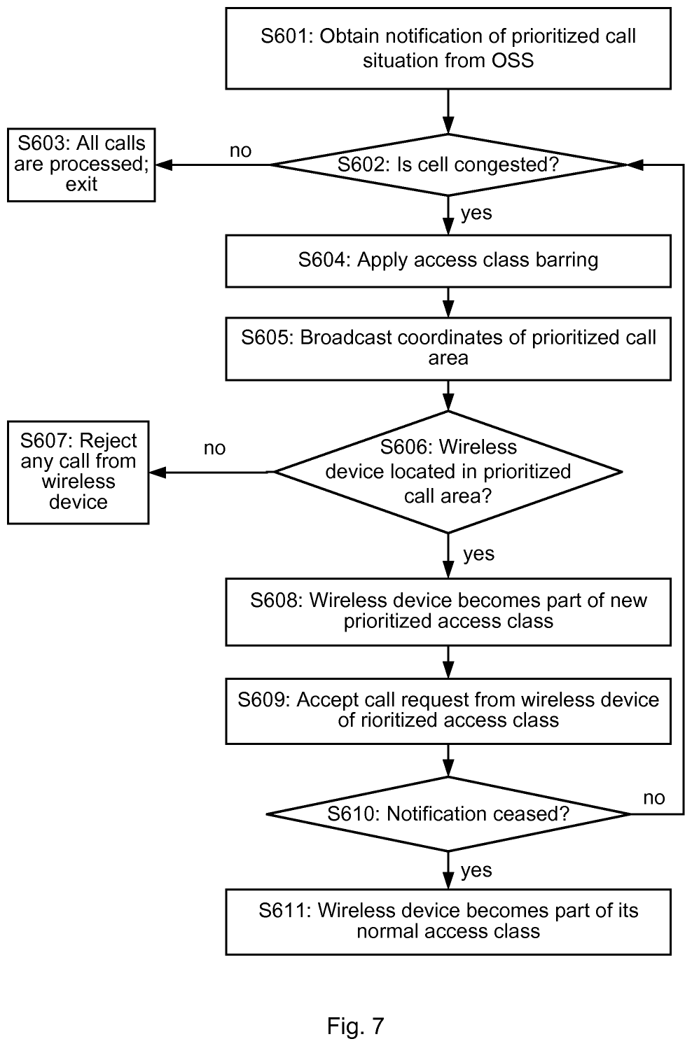

FIG. 12 schematically illustrates, in terms of a number of functional units, the components of a network server 400 according to an embodiment.

Processing circuitry 410 is provided using any combination of one or more of a suitable central processing unit (CPU), multiprocessor, microcontroller, digital signal processor (DSP), etc., capable of executing software instructions stored in a computer program product 1410c (as in FIG. 14), e.g. in the form of a storage medium 430. The processing circuitry 410 may further be provided as at least one application specific integrated circuit (ASIC), or field programmable gate array (FPGA).

Particularly, the processing circuitry 410 is configured to cause the network server 400 to perform a set of operations, or steps, as disclosed above. For example, the storage medium 430 may store the set of operations, and the processing circuitry 410 may be configured to retrieve the set of operations from the storage medium 430 to cause the network server 400 to perform the set of operations. The set of operations may be provided as a set of executable instructions. Thus the processing circuitry 410 is thereby arranged to execute methods as herein disclosed.

The storage medium 330 may also comprise persistent storage, which, for example, can be any single one or combination of magnetic memory, optical memory, solid state memory or even remotely mounted memory.

The network server 400 may further comprise a communications interface 420 for communications with other entities, nodes, functions, and devices as herein disclosed. As such the communications interface 420 may comprise one or more transmitters and receivers, comprising analogue and digital components.

The processing circuitry 410 controls the general operation of the network server 400 e.g. by sending data and control signals to the communications interface 420 and the storage medium 430, by receiving data and reports from the communications interface 420, and by retrieving data and instructions from the storage medium 430. Other components, as well as the related functionality, of the network server 400 are omitted in order not to obscure the concepts presented herein.

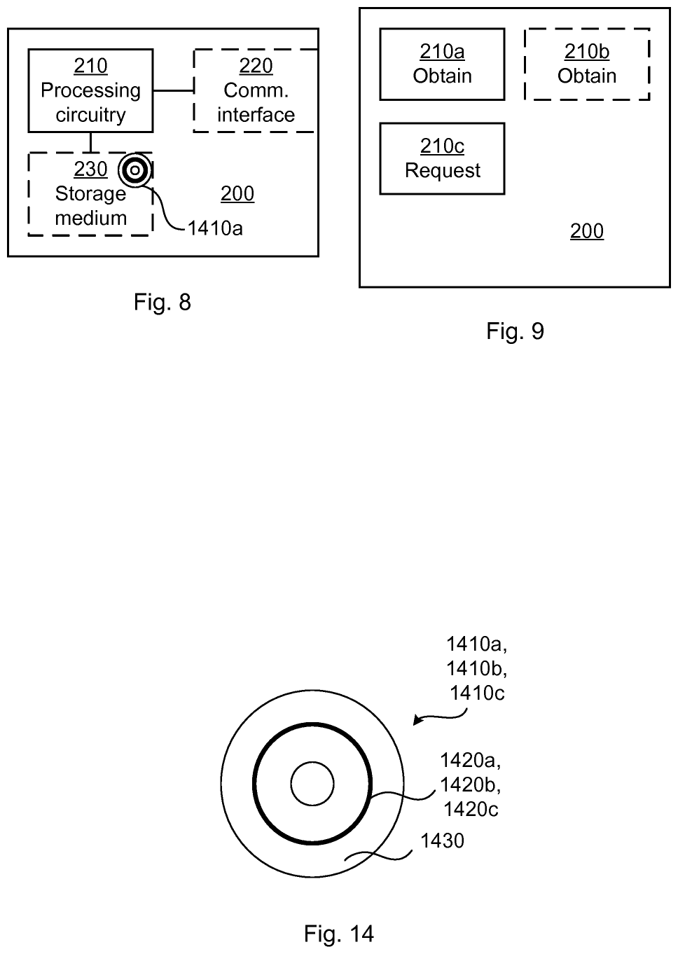

FIG. 13 schematically illustrates, in terms of a number of functional modules, the components of a network server 400 according to an embodiment. The network server 400 of FIG. 13 comprises a number of functional modules; an obtain module 410a configured to perform step S302, and a provide module 410b configured to perform step S304. The network server 400 of FIG. 13 may further comprise a number of optional functional modules. In general terms, each functional module 410a-410b may be implemented in hardware or in software. Preferably, one or more or all functional modules 410a-410b may be implemented by the processing circuitry 410, possibly in cooperation with the communications interface 420 and the storage medium 430. The processing circuitry 410 may thus be arranged to from the storage medium 430 fetch instructions as provided by a functional module 410a-410b and to execute these instructions, thereby performing any steps of the network server 400 as disclosed herein.

The network node 300a, 300b, 300c and/or network server 400 may be provided as standalone devices or as a part of at least one further device. For example, the network node 300a, 300b, 300c may be provided in a node of the radio access network or in a node of the core network and the network server 400 may be provided in a node of the core network or in a node of the service network. Alternatively, functionality of the network node 300a, 300b, 300c and/or network server 400 may be distributed between at least two devices, or nodes. These at least two nodes, or devices, may either be part of the same network part or may be spread between at least two such network parts.

Thus, a first portion of the instructions performed by the network node 300a, 300b, 300c and/or network server 400 may be executed in a respective first device, and a second portion of the of the instructions performed by the network node 300a, 300b, 300c and/or network server 400 may be executed in a respective second device; the herein disclosed embodiments are not limited to any particular number of devices on which the instructions performed by the network node 300a, 300b, 300c and/or network server 400 may be executed. Hence, the methods according to the herein disclosed embodiments are suitable to be performed by a network node 300a, 300b, 300c and/or network server 400 residing in a cloud computational environment. Therefore, although a single processing circuitry 310, 410 is illustrated in FIGS. 10 and 12 the processing circuitry 310, 410 may be distributed among a plurality of devices, or nodes. The same applies to the functional modules 310a-310j, 410a-410b of FIGS. 11 and 13 and the computer programs 1420b, 1420c of FIG. 14.

FIG. 14 shows one example of a computer program product 1410a, 1410b, 1410c comprising computer readable means 1430. On this computer readable means 1430, a computer program 1420a can be stored, which computer program 1420a can cause the processing circuitry 210 and thereto operatively coupled entities and devices, such as the communications interface 220 and the storage medium 230, to execute methods according to embodiments described herein. The computer program 1420a and/or computer program product 1410a may thus provide means for performing any steps of the wireless device 200a, 200b, 200c as herein disclosed. On this computer readable means 1430, a computer program 1420b can be stored, which computer program 1420b can cause the processing circuitry 310 and thereto operatively coupled entities and devices, such as the communications interface 320 and the storage medium 330, to execute methods according to embodiments described herein. The computer program 1420b and/or computer program product 1410b may thus provide means for performing any steps of the network node 300a, 300b, 300c as herein disclosed. On this computer readable means 1430, a computer program 1420c can be stored, which computer program 1420c can cause the processing circuitry 410 and thereto operatively coupled entities and devices, such as the communications interface 420 and the storage medium 430, to execute methods according to embodiments described herein. The computer program 1420c and/or computer program product 1410c may thus provide means for performing any steps of the network server 400 as herein disclosed.

In the example of FIG. 14, the computer program product 1410a, 1410b, 1410c is illustrated as an optical disc, such as a CD (compact disc) or a DVD (digital versatile disc) or a Blu-Ray disc. The computer program product 1410a, 1410b, 1410c could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Mash memory. Thus, while the computer program 1420a, 1420b, 1420c is here schematically shown as a track on the depicted optical disk, the computer program 1420a, 1420b, 1420c can be stored in any way which is suitable for the computer program product 1410a, 1410b, 1410c.

The inventive concept has mainly been described above with reference to a few embodiments. However, as is readily appreciated by a person skilled in the art, other embodiments than the ones disclosed above are equally possible within the scope of the inventive concept, as defined by the appended claims.

1. A method for requesting prioritized call handling, the method being performed by a wireless device, the method comprising:
obtaining an indication that the wireless device is experiencing a prioritized call situation, the indication dynamically triggering the wireless device to become part of a prioritized access class; and
requesting, during a call set-up procedure with a network node and only when the wireless device is experiencing the prioritized call situation, prioritized call handling.

2. The method according to claim 1, wherein the prioritized access class allows the wireless device to perform a call on a cell even when the cell is subject to access class barring, and wherein the prioritized call has an establishment cause that is sent in a connection request message by the wireless device to the network node during the call set-up procedure, the establishment cause indicating the call to be prioritized.

3. The method according to claim 1, wherein the indication is obtained from a sensor, the sensor being one of collocated with the wireless device and an integral part of the wireless device.

4. The method according to claim 3, wherein the sensor is one of a temperature sensor, a gas sensor, and a health monitoring sensor.

5. The method according to claim 1, wherein the indication is obtained as a notification from the network node.

6. The method according to claim 5, wherein the notification specifies a geographic area defining a prioritized call area in which the prioritized call situation occurs, the method further comprising:
obtaining location information specifying a current geographical location of the wireless device, wherein the wireless device only is requesting prioritized call handling when the current geographical location of the wireless device is one of within a predefined distance from and within, the geographic area defining the prioritized call area.

7. The method according to claim 5, wherein the prioritized access class is obtained from the network node in conjunction with the notification.

8. The method according to claim 1, wherein the prioritized access class is provided in a subscriber identity module of the wireless device.

9. The method according to claim 1, wherein the prioritized access class is defined as a dedicated access class number.

10. The method according to claim 1, wherein the prioritized access class is defined as a modification of any existing access class 0-15.

11. The method according to claim 1, wherein the prioritized access class is expended with a priority field such that a call triggered by a wireless device closest to a dangerous area, will have a higher priority over a second call coming from another wireless device that is more distant from the dangerous area than the first wireless device.

12. The method according to claim 1, wherein the wireless device before obtaining the indication is part of another, non-prioritized, access class.

13. A method for managing requested prioritized call handling from a wireless device, the method being performed by a network node, the method comprising:
obtaining, during a call set-up procedure with the wireless device, a request from the wireless device that the wireless device is requesting prioritized call handling; and
prioritizing the call handling of the wireless device in response thereto, the network node thereby managing the requested prioritized call handling from the wireless device.

14. The method according to claim 13, further comprising:
verifying that call handling of the wireless device is to be prioritized before prioritizing the call handling.

15. The method according to claim 13, further comprising:
obtaining an indication that call handling of the prioritized call situation is to be prioritized.

16. The method according to claim 14, wherein the verifying comprises:
confirming that the indication for the prioritized situation area has been obtained.

17. The method according to claim 15, wherein the indication is obtained as a notification from a network server via an Operations Support System, OSS.

18. The method according to claim 15, wherein the indication is derived from information obtained from at least one other wireless device experiencing the prioritized call situation.

19. The method according to claim 18, further comprising:
forwarding the indication to a network server.

20. The method according to claim 15, further comprising:
broadcasting, in a cell served by the network node, a notification of the prioritized call situation, wherein the notification specifies a geographic area defining a prioritized call area of the prioritized call situation.

21. The method according to claim 20, further comprising:
obtaining a further indication that prioritized call handling in the prioritized call area is to cease; and
stop stopping broadcasting the notification in response thereto.

22. The method according to claim 13, wherein the call set-up procedure pertains to the wireless device being served by the network node in a cell, and wherein, when the cell is fully congested, the method further comprises:
releasing a connection with another wireless device for which call handling is not prioritized in order to prioritize the call handling of the wireless device.

23. A method for enabling management of prioritized call handling, the method being performed by a network server, the method comprising:
obtaining an indication of a call area in which call handling is to be prioritized, the call area thus defining a prioritized call area; and
providing a notification of the indication to at least one network node serving the prioritized call area, thereby enabling the at least one network node to manage prioritized call handling in the prioritized call area.

24. The method according to claim 23, wherein the notification is provided to the at least one network node via an Operations Support System, OSS.

25. The method according to claim 23, wherein the indication is obtained from an emergency service center.

26. The method according to claim 23, wherein the indication is obtained from at least one sensor device located in the prioritized call area.

27. The method according to claim 23, wherein the indication is obtained, via a network node and via an Operations Support System, OSS, from at least one wireless device located in the prioritized call area.

28. The method according to claim 23, wherein the prioritized call area corresponds to a geographic area, wherein indication is caused by an incident having occurred in the geographic area, and wherein the indication identifies the geographic area and type of incident having occurred.

29. The method according to claim 23, wherein the notification further is provided to at least one other network node serving a call area neighbouring the prioritized call area.

30. A wireless device for requesting prioritized call handling, the wireless device comprising processing circuitry, the processing circuitry being configured to cause the wireless device to:
obtain an indication that the wireless device is experiencing a prioritized call situation, the indication dynamically triggering the wireless device to become part of a prioritized access class; and
request, during a call set-up procedure with a network node and only when the wireless device is experiencing the prioritized call situation, prioritized call handling.

31. (canceled)

32. (canceled)

33. A network node for managing requested prioritized call handling from a wireless device, the network node comprising processing circuitry, the processing circuitry being configured to cause the network node to:
obtain, during a call set-up procedure with the wireless device, a request from the wireless device that the wireless device is requesting prioritized call handling; and
prioritize the call handling of the wireless device in response thereto, the network node thereby managing the requested prioritized call handling from the wireless device.

34. (canceled)

35. (canceled)

36. A network server for enabling management of prioritized call handling, the network server comprising processing circuitry, the processing circuitry being configured to cause the network server to:
obtain an indication of a call area in which call handling is to be prioritized, the call area thus defining a prioritized call area; and
provide a notification of the indication to at least one network node serving the prioritized call area, thereby enabling the at least one network node to manage prioritized call handling in the prioritized call area.

37-42. (canceled)
